(19) United States
(12) Patent Application Publication
(10) Pub. No.: US 2013/0253967 A1
(43) Pub. Date: Sep. 26, 2013

(54) SUPPLY-DEMAND PAIRING SYSTEM AND METHOD THEREOF

(71) Applicant: MENG SINGLE, Foshan City (CN)

(72) Inventor: MENG SINGLE, Foshan City (CN)

(73) Assignees: MITAC COMPUTER (SHUN DE) LTD., Foshan City (CN); MITAC INTERNATIONAL CORP., TAOYUAN COUNTY (TW)

(21) Appl. No.: 13/752,979

(22) Filed: Jan. 29, 2013

(30) Foreign Application Priority Data
Mar. 23, 2012 (CN) 201210080285.5

(51) Int. Cl. G06Q 10/08

(52) U.S. Cl. CPC G06Q 10/08
USPC 705/7.11

(57) ABSTRACT

A supply-demand pairing system and its method are disclosed. The supply-demand pairing system comprises a demand side device, a supply side device and a server. The demand side device is used to locate, and used to provide a demander to input demand information to send a demand message to the server. The supply side device is used to locate, and used to provide a suppliers to input supply information to send a supply message to the server. The server is used to compare the demand message and the supply message to execute a supply-demand pairing, and used to send the demand message and the supply message to the supply side device and the demand side device respectively for making the demand side device can communicate with the supply side device.

### CROSS-REFERENCE TO RELATED APPLICATION

This application claims the benefit of China Patent Application No. 201210080285.5, filed on Mar. 23, 2012, in the State Intellectual Property Office of the People's Republic of China, the disclosure of which is incorporated herein in its entirety by reference.

### BACKGROUND OF THE INVENTION

1. Field of the Invention

The present invention relates to a supply-demand pairing system and its method, and more particularly to a supply-demand pairing system capable of utilizing a GPS device to perform supply-demand searching and further performing supply-demand pairing and its method.

2. Description of the Related Art

People will usually need to deal with a number of uncertain transactions or activities during daily life. However, these transaction or activities are usually contingencies or spontaneous such as vehicle riding when going out, shopping somewhere spontaneously, outdoor rescue, transportation and market message search for any given place or time and the like. These may become uncertainty in accordance with the changes of time and location. The foregoing situations are that first, messages required by the transactions or activities may not be effectively collected in real-time; second, resources capable of being assigned to the transactions or activities are varied in accordance with the changes of time and location, resulting in uncertainty. Thus, the achieved efficiency and success ratios are not positive.

The current market does not have corresponding systems to support and guide the market. Various related platforms such as business platforms or shopping platforms may not have sufficient contact with each other and have no significant effect. How to conveniently and quickly collect transaction messages and maximize resource dispatch is a key of facilitating these kinds of transactions or activities. Therefore, the invention is to provide a system capable of quickly and conveniently achieving supply-demand transaction such that transaction resources can be effectively utilized in each transaction.

### SUMMARY OF THE INVENTION

In view of the shortcomings of the prior art, the inventor(s) of the present invention based on years of experience in the related industry to conduct extensive researches and experiments, and finally developed a supply-demand pairing system and its method as a principle objective to overcome the problems of inconvenience of transactions in the market and the difficulty in obtaining demand and supply information rapidly and effectively.

To achieve the foregoing objectives of the invention, a supply-demand pairing system is provided and comprises a demand side device, a supply side device and a server. The demand side device includes first identification information and GPS positioning function to position a current location to generate first current location information. The demand side device further receives demand information inputted by a demander to package first identification information, first current location information and demand information into a demand message that is delivered. The supply side device has second identification information and GPS positioning function to position current location to generate second current location information, and the supply side device further receives supply information inputted by a supplier to package second identification information, second current location information and supply information into a supply message that is delivered. The server receives and compares the demand message with the supply message to perform supply-demand pairing and respectively send the demand message and the supply message to the supply side device and the demand side device such that the demand side device and the supply side device that have been paired can communicate with each other through first identification information and second identification information.

Preferably, the demand side device includes a positioning module, an input module, a processing module and a transmission module. The positioning module positions the current location of the demand side device to generate first current location information. The input module is provided to a demander to input demand information and provided to the demander to input a script message communicating with the supply side device that has been paired. The processing module is connected to the positioning module and the input module to package first identification information, first current location information and demand information into the demand message. The transmission module is connected to the processing module to send the demand message and the script message.

Preferably, the supply side device includes a positioning module, an input module, a processing module and a transmission module. The positioning module positions the supply side device to generate second current location information. The input module is provided to the supplier to input supply information and provided to the supplier to input a script message communicating with the demand side device that has been paired. The processing module is connected to the positioning module and the input module to package second identification information, second current location information and supply information into a supply message. The transmission module is connected to the processing module to transmit the supply message and the script message.

Preferably, the demand side device and the supply side device respectively include a display module to allow the demand side device to display the second current location information and the supply message through the display module such that the supply side device displays the first current location and the demand message.

Preferably, first identification information and second identification information can include an IP address, a media access control (MAC) address, a physical address or a phone number.

Preferably, the demand side device and the supply side device respectively include a communication module to provide the demand side device and the supply side device to perform audio or video communication.

Preferably, the demand side device and the supply side device respectively include an image capturing module to provide the demander and the supplier to capture images, thereby generating image information. The demand side device and the supply side device then respectively package image information into the demand message and the supply message that then are transmitted to the server.

Preferably, the server compares the first current location information in the demand message with the second current location information in the supply message. If the first current location information and the second current location information are at the regional area, the server will perform supply-demand pairing.

Preferably, the server compares demand information in the demand message with supply information in the supply message. If contents of demand information and supply information correspond to each other, the server will perform supply-demand pairing.

Preferably, the server further stores the demand message and the supply message.

Preferably, when the server receives another demand message sent by another demand side device, the server will perform a demand determination to compare whether or not the demand message corresponds to another demand message, if yes, a demand advice message is generated and transmitted to the demand side device and another demand side device to allow the demand side device communicating with another demand side device, and the demand side device and the other demand side device can simultaneously obtain services provided by the supply side device.

Preferably, the demand side device and the supply side device are provided to a demander and a supplier to selectively perform supply-demand transaction after performing pairing, and the demand side device and the supply side device are further provided to the demander and the supplier to input a transaction success-failure message after performing the transaction communication. The server stores the transaction success-failure message, and when the demand side device or the supply side device look for supply-demand pairing in future, the transaction success-failure message is sent to the demand side device or the supply side device through the server.

According to an objective of the invention, a method for supply-demand pairing is provided and comprises the following steps: using a demand side device having first identification information and a GPS positioning function to position a current location to generate first current location information and providing a demander to input demand information; packaging first identification information, first current location information and demand information into a demand message through the demand side device and sending the demand message; using a supply side device having second identification information and a GPS positioning function to position a current location to generate second current location information and providing a supplier to input supply information; packaging second identification information, second current location information and supply information into a supply message through the supply side device and sending the supply message; providing a server to receive the demand message and the supply message and performing comparison, wherein when the demand message corresponds to the supply message, performing supply-demand pairing through the server; and respectively sending the demand message and the supply message to the supply side device and the demand side device through the server to allow the demand side device and the supply side device that are paired to communicate with each other through the first identification information and the second identification information

The supply-demand pairing system and its method according to the invention have one or more advantages as the following:

(1) The supply-demand pairing system and its method according to the invention utilize the electronic device having a GPS function to perform positioning and send demand and supply information. It can quickly and effectively allow the demander and the supplier to obtain the respective demands and services provided of each other, and provided from each other, allowing both the demander and the supplier to acquire the best transaction quality. Accordingly, overall economic effectiveness is improved.

(2) The supply-demand pairing system and its method according to the invention continuously receive the demand message and the supply message through the server to collect adequate transaction information such that each transaction can be accurately paired and regulated. The server can also plan different transaction solutions for the demander and the supplier to allow both parties to further execute more trades.

### BRIEF DESCRIPTION OF THE DRAWINGS

FIG. 1 a is block diagram of a supply-demand pairing system according to the invention;

FIG. 2 is a flowchart of a method for supply-demand pairing according to the invention;

FIG. 3A is a first schematic diagram of a supply-demand pairing system and its method according to a first embodiment of the invention;

FIG. 3B is a second schematic diagram of a supply-demand pairing system and its method according to a first embodiment of the invention;

FIG. 3C is a third schematic diagram of a supply-demand pairing system and its method according to a first embodiment of the invention;

FIG. 3D is a fourth schematic diagram of a supply-demand pairing system and its method according to a first embodiment of the invention;

FIG. 3E is a fifth schematic diagram of a supply-demand pairing system and its method according to a first embodiment of the invention;

FIG. 4 is a first schematic diagram of a supply-demand pairing system and its method according to a second embodiment of the invention;

FIG. 5 is a second schematic diagram of a supply-demand pairing system and its method according to a second embodiment of the invention.

### DETAILED DESCRIPTION OF THE PREFERRED EMBODIMENTS

The foregoing and other technical characteristics of the present invention will become apparent with the detailed description of the preferred embodiments and the illustration of the related drawings.

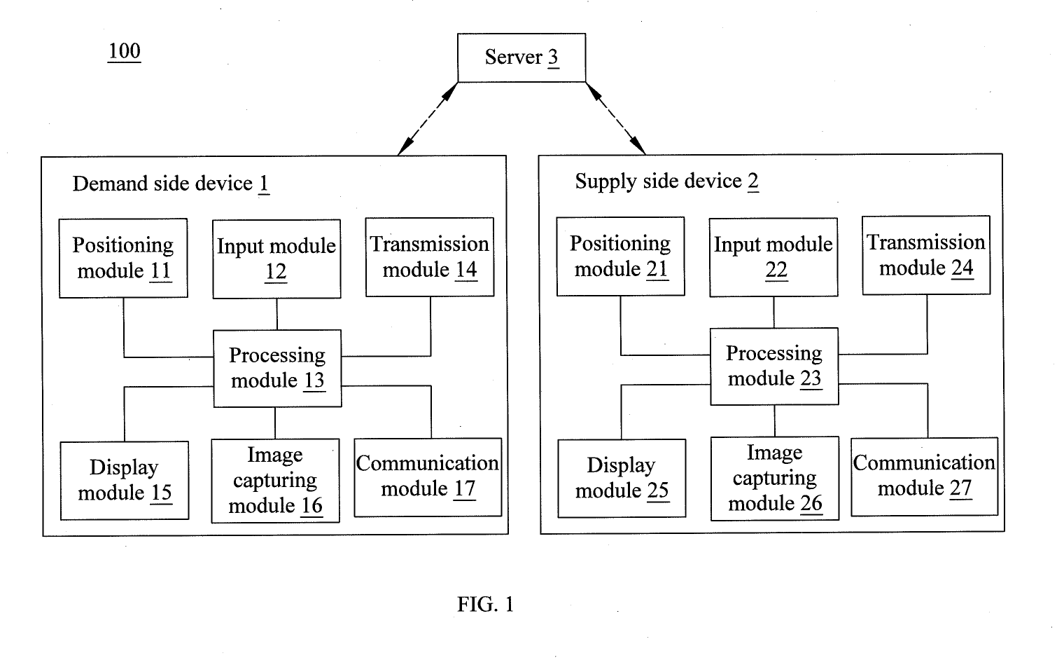

With reference to FIG. 1 for a block diagram of a supply-demand pairing system according to the invention is depicted. In the figure, the supply-demand pairing system 100 comprises a demand side device 1, a supply side device 2 and a server 3. The demand side device 1 and the supply side device 2 can be electronic devices such as a mobile phone having GPS positioning and navigation functions, or a PDA. The demand side device 1 and the supply side device 2 respectively corresponds to first identification information and second identification information. The first identification information and the second identification information can be an IP address, a media access control (MAC) address, a physical address or a phone number for identifying the demand side device 1 and the supply side device 2. The server 3 can be a remote host. The demand side device 1 and the supply side device 2 can be connected to the server 3 via the Internet. The demand side device 1 comprises a positioning module 11, an input module 12, processing module 13, a transmission module 14, a display module 15, an image capturing module 16 and a communication module 17. The processing module 13 is connected to the positioning module 11, the input module 12, the transmission module 14, the display module 15, the image capturing module 16 and the communication module 17. The supply side device 2 includes a positioning module 21, an input module 22, the processing module 23, the transmission module 24, a display module 25, an image capturing module 26 and the communication module 27. The processing module 23 is connected to the positioning module 21, the input module 22, the transmission module 24, the display module 25, the image capturing module 26 and the communication module 27. The input modules 12, 22 can be keypads or such device. The display modules 15, 25 can be monitors. The input module 12 and the display module 15 and the input module 22 and the display module 25 can be integrated into a touch input panel respectively. The image capturing modules 16, 26 can be a lens, an image sensing component or a foregoing combination. The transmission modules 14, 24 can be a network interface for uploading data of scripts, figures or images to the Internet. The communication modules 17, 27 can be a communication chip providing audio or video communication.

The positioning module 11 of the demand side device 1 can position the current location of the demand side device to generate first current location information. The input module 12 can provide a user to input demand information, wherein demand information can include a transport request demand, shopping demand, information search demand or rescue demand. The user can input data corresponding to these demands. For example, transport request demand can include inputting information of number of passengers and destinations. The processing module 13 can package first identification information, first current location information and demand information into a demand message. The transmission module 14 can deliver the demand message to the server 3 through a network. The positioning module 21 of the supply side device 2 can perform positioning for the supply side device 2 to generate second current location information. The input module 22 can provide the user to input supply information. Supply information can include riding service, shopping service, road rescue service, information search service. The supplier further input related information based upon each inputted service item. For example, the riding service can include inputting the riding quantity or locations. The processing module 23 can package second identification information, second current location information and supply information into a supply message. The transmission module 24 can send the supply message to the server 3. When the server 3 receives the demand message and the supply message, the demand message and the supply message are stored and a comparison is performed. First current location information in the demand message is compared with second current location information in the supply message. Alternatively, demand information in the demand message is compared with supply information in the supply message. Alternatively, first identification information is compared with second identification information. If first current location information and second current location information are at the same regional area or if the content in demand information corresponds to the content in supply information or if first identification information corresponds to second identification information, the server 3 executes a supply-demand pairing action to send the demand message to the supply side device 2 and to send the supply message to the demand side device 1 such that the demand side device 1 is connected to the supply side device 2 through second identification information, and the supply side device 2 is connected to the demand side device 1 through first identification information. Accordingly, the demand side device 1 is connected to the supply side device 2 to achieve communication.

When the demand side device 1 is connected to the supply side device 2, communication between the demander and the supplier can be achieved by inputting script messages or picture messages through the input modules 12, 22 respectively. These messages then are transmitted by the transmission modules 14, 24. Further, audio or video communication between the demander and the supplier can be performed by respectively utilizing the communication modules 17, 27 to talk to each other. The demander can observe second current location information of the supply side device 2 through the display module 15 to obtain the location of rescuers, and supply information generated by the supply side device 2 can be displayed by the display module 15. The supplier can search first current location information of the demand side device 1 through the display module 25 to further obtain the position of the demander. The display module 25 further displays demand information inputted by the demander.

The demander also utilizes the image capturing module 16 to perform image capturing to generate image information. The processing module 13 packages image information into the demand message and uploads it to the server 3. The supplier can further utilize the image capturing module 26 to capture images to generate image information. The processing module 23 packages image information in the supply message to deliver it to the server 3. Accordingly, the supply side device 1 and the supply side device 2 that have been paired can display image information through the display modules 15, 25 respectively to clearly capture demands of the demander and services provided by the supplier.

After the demand side device 1 and the supply side device 2 are paired, they can be provided to the demander and the supplier to selectively perform supply-demand transaction. Regardless of the transaction agreement achieved by the demander and the supplier during transaction communication, the demand side device 1 and the supply device 2 can be respectively provided to the demander and the supplier to input a transaction success-failure message after transaction communication. The server 3 stores the transaction success-failure message to form a record for transaction success or transaction failure such that when the demand side device 1 or the supply side device 2 looks for supply-demand pairing in future, the transaction success-failure message is delivered to the demand side device 1 or the supply side device 2 through the server 3. The foregoing manner can allow the demander or the supplier to select and eliminate bad buyers or sellers based upon the transaction success-failure message.

In addition, when the server 3 receives the demand message sent from another demand side device again, the server 3 does not only compare with the supply message, but also performs a demand determination to compare the demand message generated by the demand side device 1 with the demand message generated by the another demand side device. If the server 3 determines that two demand messages correspond to each other, a demand advice message is generated, and the demand advice message then is transmitted to the demand side device 1 and another demand side device to allow the demand side device 1 and another demand side device to communicate with each other such that the demand side device 1 and the other demand side device can obtain services provided by the supply side device at the same time. For example, when demand information in the demand messages generated by the demand side device 1 and another demand side device correspond to each other, the server 3 would generate a demand advice message, and the message is displayed on the demand side device 1 and another demand side device to remind them that demands requested by another demander are identical to the demand requested by the original demander. The demand advice message can further include benefits or discounts obtained by simultaneously executing demand ordering through many demanders.

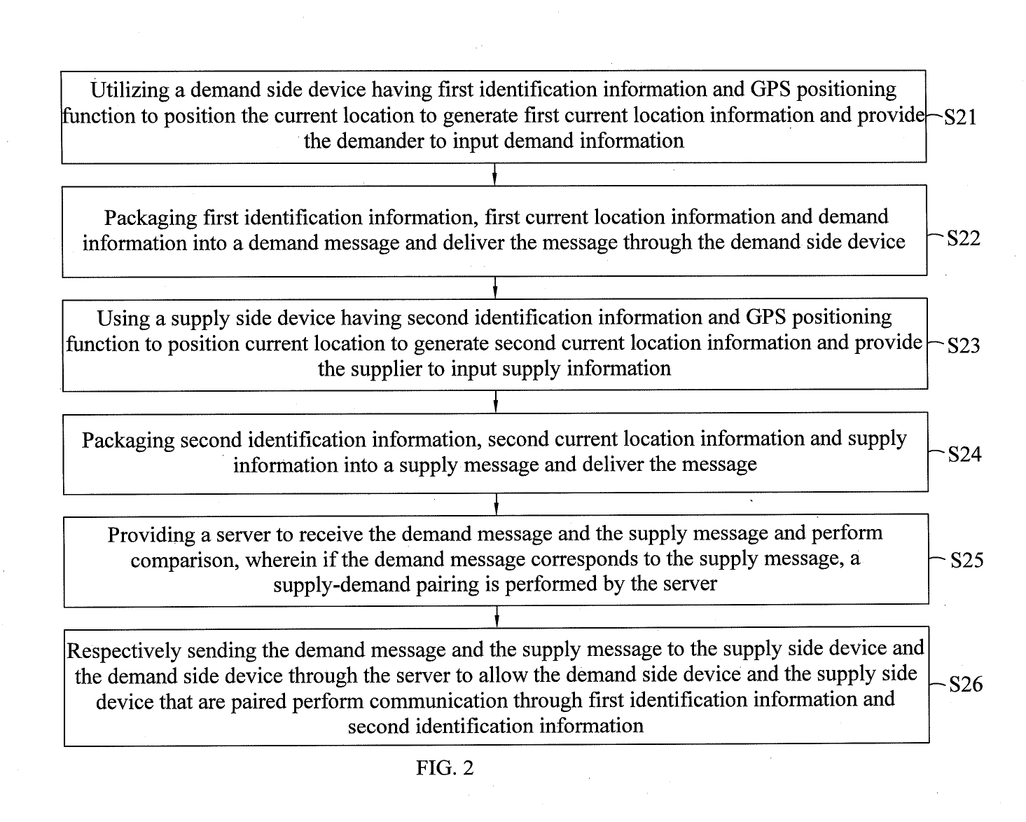

With reference to FIG. 2 for a flowchart of a method for supply-demand pairing according to the invention is depicted. The method comprises the following steps: S21: utilizing a demand side device having first identification information and GPS positioning function to position the current location to generate first current location information and provide the demander to input demand information; S22: packaging first identification information, first current location information and demand information into a demand message and deliver the message through the demand side device; S23: using a supply side device having second identification information and GPS positioning function to position current location to generate second current location information and provide the supplier to input supply information; S24: packaging second identification information, second current location information and supply information into a supply message and deliver the message; S25: providing a server to receive the demand message and the supply message and perform comparison, wherein if the demand message corresponds to the supply message, a supply-demand pairing is performed by the server; S26: respectively sending the demand message and the supply message to the supply side device and the demand side device through the server to allow the demand side device and the supply side device that are paired perform communication through first identification information and second identification information.

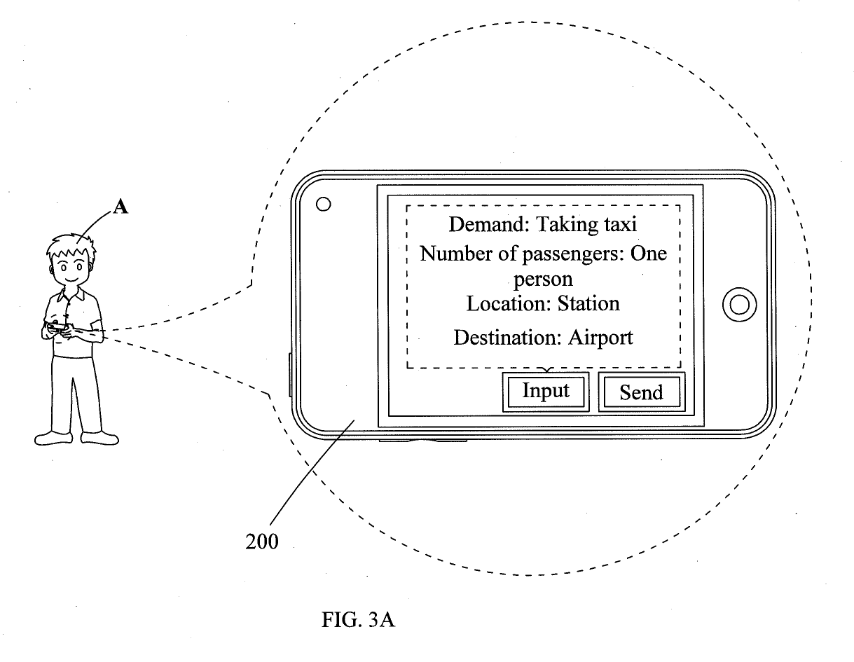

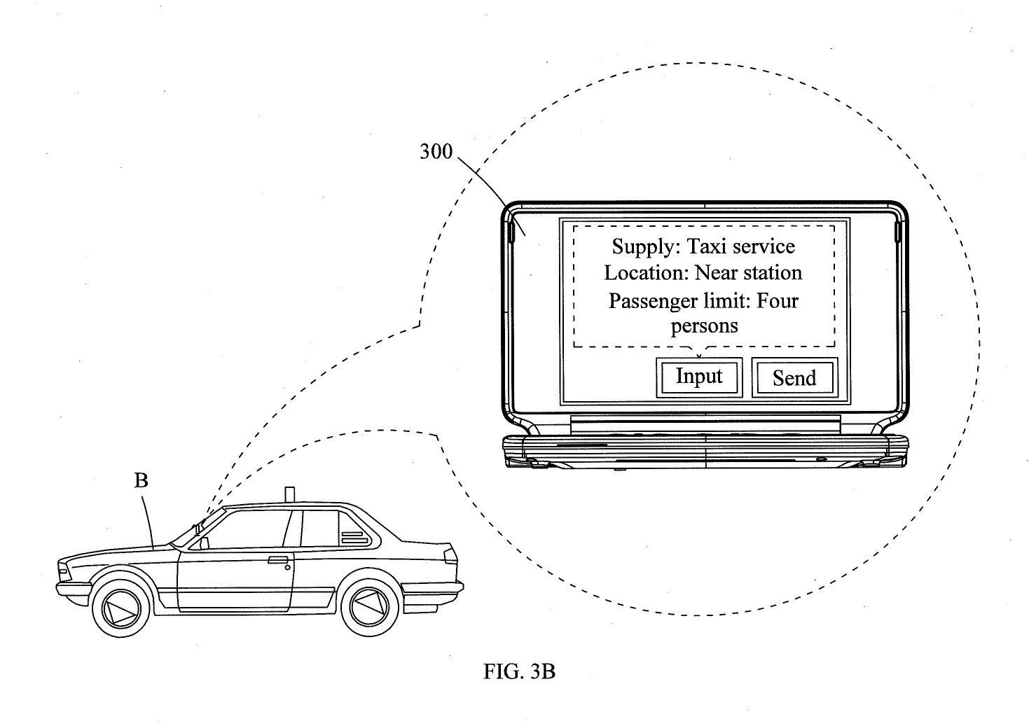

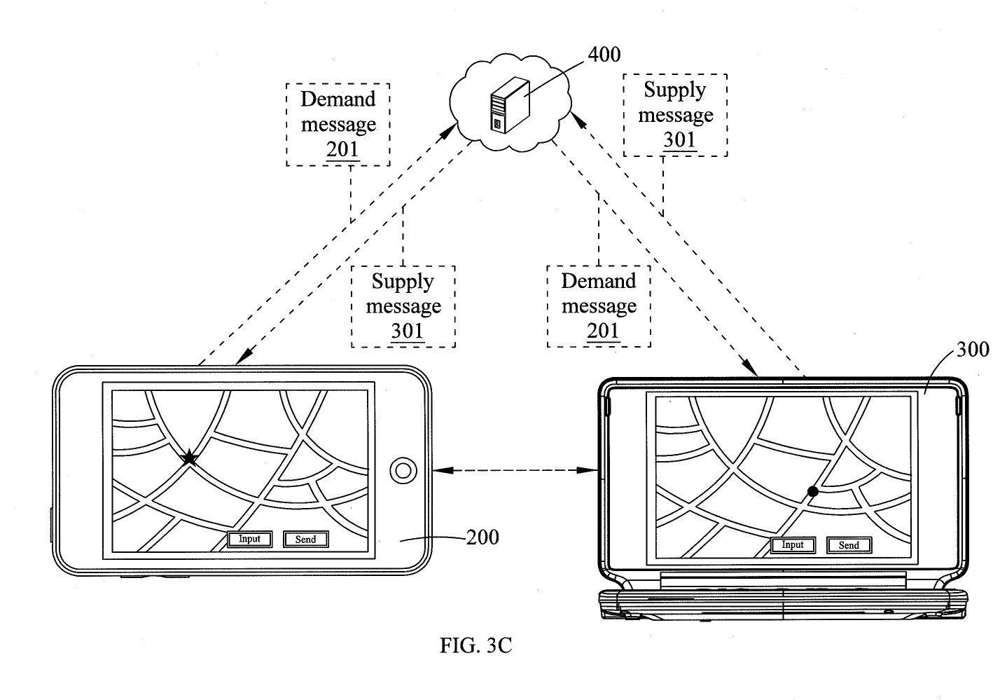

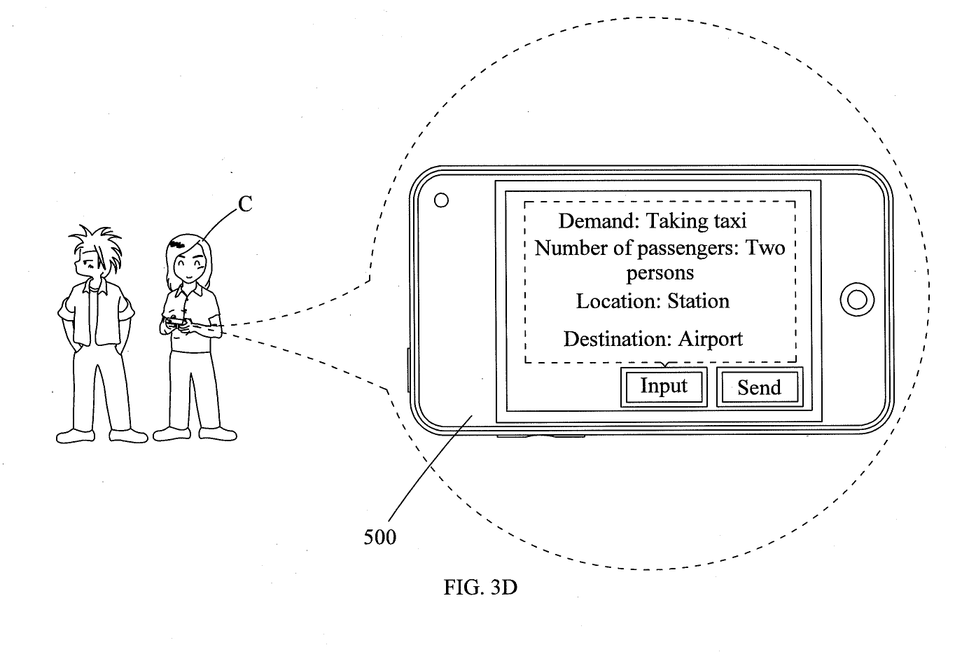

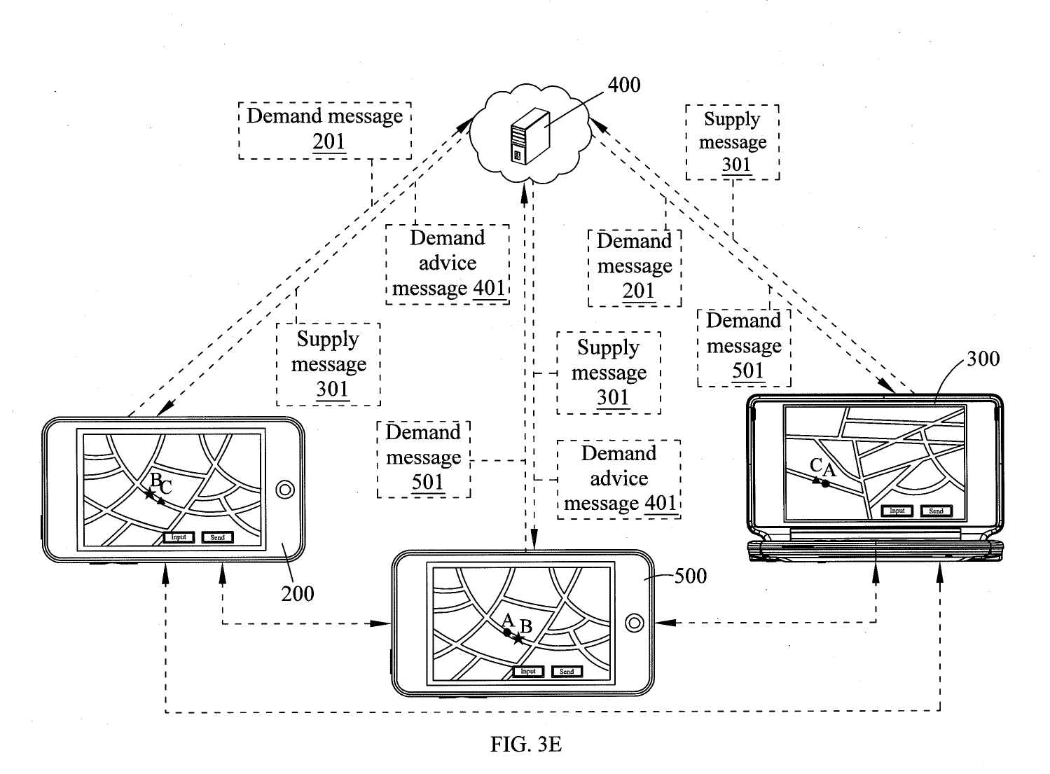

With reference to FIG. 3A to FIG. 3E for a first schematic diagram, a second schematic diagram, a third schematic diagram, a fourth schematic diagram and a fifth schematic diagram of a supply-demand pairing system and its method according to the invention are depicted. The embodiment applies the supply-demand pairing system to transportation. In the embodiment, when a passenger A would like make a request for a Taxi e, an input key of a hand-held electronic device 200 having GPS function is utilized to input demand information. Demand information can include “taking taxi”, passenger quantity “one person”, location “Station” and destination “Airport”. As shown in FIG. 3A, the passenger A can, but is not limited to, still input other demand information contents. In the embodiment, a GPS device 300 is included and can be disposed in a taxi B. A driver of the taxi B can utilize the GPS device 300 to input supply information. Supply information can include “taxi service, location” near Taipei Station” and Passenger limit “four persons”. However, the driver can also input other data as shown in FIG. 3B. When the passenger A and the driver of the taxi B respectively input demand information and supply information, a sending key is pressed to respectively deliver a demand message 201 and a supply message 301 to the server 400, wherein the demand message 201 and the supply message 301 do not only include demand information supply information respectively inputted by the passenger A and the driver of the taxi B, but also include IP address, MAC (media access control) address, physical address or identification information of phone numbers and current location information generated by the hand-held electronic device 200 and the GPS device 300 respectively performing positioning. When the server 3 receives the demand message 201 and the supply message 301, a comparison will be performed. Since contents of demand information and supply information in the demand message 201 and the supply message 301 can correspond to each other, the server 3 will send the supply message 301 to the hand-held electronic device 200 and send the demand message 201 to the GPS device 300 to allow the hand-held electronic device 200 communicating with the GPS device 300 such that the passenger A performs transaction negotiation with the driver of the taxi B as shown in FIG. 3C. The passenger A and the driver of the taxi B can communicate with each other through manners of scripts, figures, images, audio or video. In addition, the server 3 will store the demand message 201 and the supply message 301 to form a record to ensure the rights of two parties.

If there is another passenger C, the passenger C can also utilize the hand-held electronic device 500 having GPS to input demand information, wherein demand information can include demand “taking taxi”, passenger quantity “two persons”, location “Taipei Station” and destination “airport” as shown in FIG. 3D. When the passenger C would like to send demand information, the hand-held electronic, device 500 will package demand information, identification information of the hand-held electronic device 500 and current location information that has been positioned into a demand message 501 and send the message to the server 400. If the server 400 simultaneously receives the demand message 201, the supply message 301 and the demand message 501 within a time range, the demand messages 201, 501 are respectively compared with the supply message 301, and the demand message 201 and the demand message 501 are determined. Herein the demand message 501 corresponds to the supply message 301. Therefore, the server 400 will transmit the demand message 501 to the GPS device 300 and send the supply message 301 to the hand-held electronic device 500 to allow the hand-held electronic device 500 communicating with the GPS device 300. If the server 400 determines that the demand message 501 corresponds to the demand message 201, a demand advice message 401 will be generated, and the demand advice message 401 will be sent to the hand-held electronic devices 200 and 500 such that the hand-held electronic devices 200 and 500 can communicate with each other. The demand advice message 401 includes a car-pool discount plan to allow the passenger A and the passenger C to decide whether or not both passengers would like to take the taxi B together based upon the demand advice message 401 as shown in FIG. 3E. The hand-held electronic device 200, the GPS device 300 and the hand-held electronic device 500 can display their locations through screen panels and each demand message 201 and 501, the supply message 301 and the demand advice message 401.

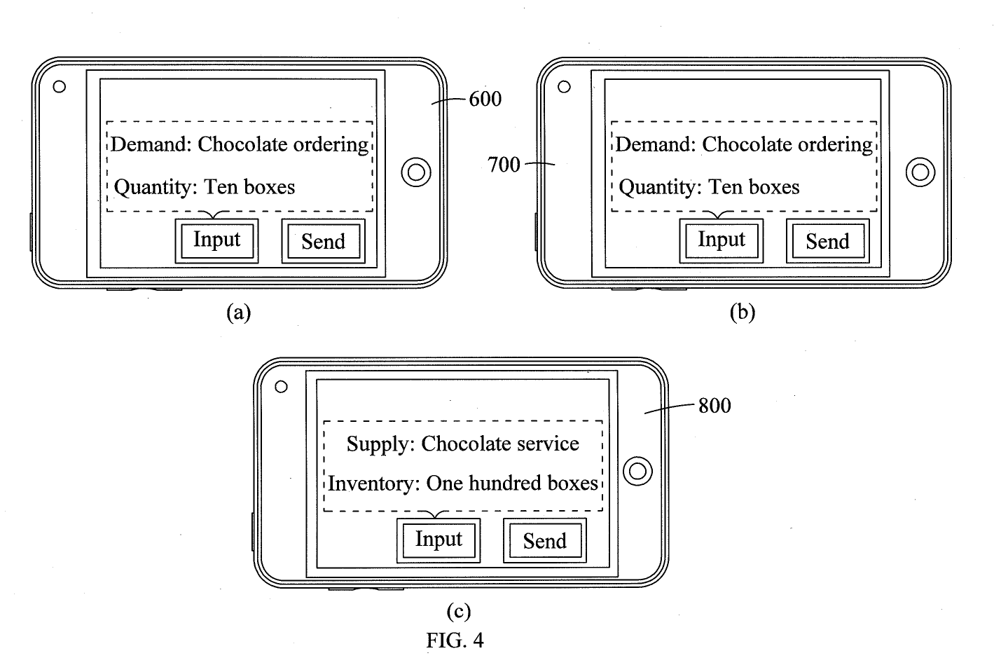

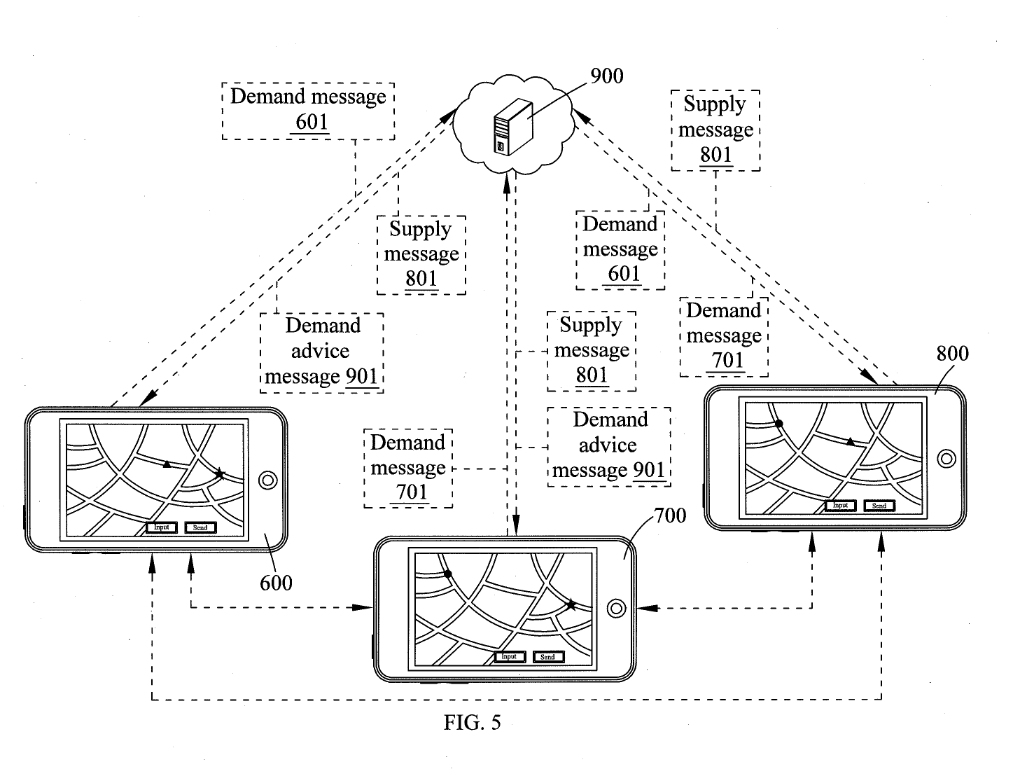

With reference to FIG. 4 and FIG. 5 for a first schematic diagram and a second schematic diagram of a supply-demand pairing system and its method according to a second embodiment of the invention are depicted. In FIG. 4, three hand-held electronic devices 600, 700 and 800 are provided. The hand-held electronic device 600 is provided to a demander to input demand information. Demand information is demand “chocolate ordering” and quantity “ten boxes” as shown in (a) figure of FIG. 4. The hand-held electronic device 700 shown in a (b) figure of FIG. 4 is provided to another demander to input demand information including demand “chocolate ordering” and quantity “thirty boxes”. The hand-held electronic device 800 shown in a (c) figure of FIG. 4 is provided to a supplier to input supply information. Supply information includes “chocolate ordering service” and inventory “one hundred boxes” as shown in (c) figure of FIG. 4. When the hand-held electronic devices 600, 700 and 800 respectively package demand information and supply information into demand messages 601, 701 and a supply message 801, and when these messages are sent to a server 900, the server 900 compares the demand messages 601, 701 with the supply message 801. If the demand messages 601, 701 mutually correspond to the supply message 801. The server 900 will generate a demand advice message 901, and the supply message 801 and the demand advice message 901 are sent to the hand-held devices 600, 700, and the demand messages 601, 701 are sent to the hand-held electronic device 800 to allow demanders of the hand-held electronic devices 600, 700 to perform transaction negotiation with the supplier of the hand-held electronic device 800. The hand-held electronic device 600 can communicate with the hand-held electronic device 700 based upon the demand advice message 801 to decide ordering chocolate through group purchase, thereby obtaining preferable discounts as shown in FIG. 5.

The supply-demand pairing system and its method of the invention mainly allow both demand and supply parties to use electronic devices having GPS function to perform positioning and deliver the demand and supply messages. Accordingly, both supply and demand parties can quickly and precisely obtain messages of supply and demand services respectively to achieve the quality and benefits of the best transaction.

The invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A supply-demand pairing system comprising:
a demand side device having first identification information and a GPS (global positioning system) positioning function to position a current location to generate first current location information, the demand side device further receiving demand information inputted by a demander to package first identification information, first current location information and demand information into a demand message that is sent;
a supply side device having second identification information and a GPS positioning function to position a current location to generate second current location information, the supply side device further receiving supply information inputted by a supplier to package second identification information, second current location information and supply information into a supply message that is transmitted; and
a server for receiving and comparing the demand message with the supply message to perform a supply-demand pairing to respectively send the demand message and the supply message to the supply side device and the demand side device such that the demand side device and the supply side device communicate with each other through first identification information and second identification information.

2. The supply-demand pairing system as recited in claim 1, wherein the demand side device comprises a positioning module, an input module, a processing module and a transmission module, and the positioning module position the current location of the demand side device to generate the first current location information; and the input module is provided to the demander to input demand information and allows the demander to input a script message to communicate with the supply side device, and the processing module is connected to the positioning module and the input module to package first identification information, first current location information, and demand information into the demand message, and the transmission module is connected to the processing module to send the demand message and the script message.

3. The supply-demand pairing system as recited in claim 1, wherein the supply side device comprises a positioning module, an input module, a processing module and a transmission module, and the positioning module positions the supply side device to generate the second current location information, and the input module is provided to the supplier to input supply information and allows the supplier to input a script message communicating with the demand side device, and the processing module is connected to the positioning module and the input module to package second identification information, second current location information and supply information into the supply message, and the transmission module is connected to the processing module to send the supply message and the script message.

4. The supply-demand pairing system as recited in claim 1, wherein the demand side device and the supply side device respectively comprise a display module to allow the demand side device to display the second current location information and the supply message through the display module such that the supply side device displays the first current location information and the demand message through the display module.

5. The supply-demand pairing system as recited in claim 1, wherein first identification information and second identification information comprise an internet protocol address, a media access control address, a physical address or a phone number.

6. The supply-demand pairing system as recited in claim 1, wherein the demand side device and the supply side device respectively comprise a communication module to perform audio or video communication between the supply side device and the demand side device.

7. The supply-demand pairing system as recited in claim 1, wherein the demand side device and the supply side device respectively comprise an image capturing module to respectively provide the demander and the supplier to capture images, thereby generating image information, and the demand side device and the supply side device respectively package image information into the demand message and the supply message that are sent to the server.

8. The supply-demand pairing system as recited in claim 1, wherein the server compares the first current location information in the demand message with the second current location information in the supply message, and when the first current location information and the second current location information are at a same regional area, the server performs supply-demand pairing.

9. The supply-demand pairing system as recited in claim 1, wherein the server compares demand information in the demand message and supply information in the supply message, and when a content of demand information correspond to a content of supply information, the server performs supply-demand pairing.

10. The supply-demand pairing system as recited in claim 1, wherein the server further stores the demand message and the supply message.

11. The supply-demand pairing system as recited in claim 1, wherein when the server receives another demand message sent by another demand side device, the server further performs a demand determination to compare whether or not the demand message corresponds to another demand message, if yes, a demand advice message is generated and transmitted to the demand side device and another demand side device such that the demand side device and another demand side device communicate with each other, and the demand side device and another demand side device simultaneously obtain services provided by the supply side device.

12. The supply-demand pairing system as recited in claim 1, wherein the demand side device and the supply side device are provided to the demander and the supplier to selectively perform supply-demand transaction after pairing, and the demand side device and the supply side device are further provided to the demander and the supplier to input a transaction success-failure message after performing transaction communication, and the server stores the transaction success-failure message, and when the demand side device or the supply side device looks for supply-demand pairing in future, the transaction success-failure message is sent to the demand side device or the supply side device through the server.

13. A method for supply-demand pairing comprising:
using a demand side device having first identification information and a GPS positioning function to position a current location to generate first current location information and providing a demander to input demand information;
packaging first identification information, first current location information and demand information into a demand message through the demand side device and sending the demand message;
using a supply side device having second identification information and a GPS positioning function to position a current location to generate second current location information and providing a supplier to input supply information;
packaging second identification information, second current location information and supply information into a supply message through the supply side device and sending the supply message;
providing a server to receive the demand message and the supply message and performing comparison, wherein when the demand message corresponds to the supply message, performing supply-demand pairing through the server; and
respectively sending the demand message and the supply message to the supply side device and the demand side device through the server to allow the demand side device and the supply side device that are paired to communicate with each other through the first identification information and the second identification information.

14. The method for supply-demand pairing as recited in claim 13, further comprising a step:
displaying the second current location information and supply information of the supply side device through the demand side device, and displaying the first current location information and demand information of the demand side device through the supply side device.

15. The method for supply-demand pairing as recited in claim 13, further comprising a step:
utilizing the demand side device and the supply side device to respectively capture images to generate image information, and packaging image information into the demand message and the supply message that are sent to the server.

16. The method for supply-demand pairing as recited in claim 13, wherein the demand side device and the supply side device communicate with each other through a script message, audio or video manner.

17. The method for supply-demand pairing as recited in claim 13, further comprising steps:
receiving another demand message sent by another demand side device through the server; and
utilizing the server to perform a demand determination to determine whether or not the demand message corresponds to another demand message, if yes, generating and sending a demand advice message to the demand side device and another demand side device such that the demand side device communicates with another demand side device, and the demand side device and another demand side device are simultaneously obtaining services provided by the supply side device.

18. The method for supply-demand pairing as recited in claim 13, further comprising steps:
providing the demander and the supplier to selectively perform supply-demand transaction through the demand side device and the supply side device, and respectively providing the demander and the supplier to input a transaction success-failure message through the demand side device and the supply side device after performing transaction communication; and
utilizing the server to store the transaction success-failure message, sending the transaction success-failure message to the demand side device or the supply side device through the server when the demand side device or the supply side device is looking for supply-demand pairing in future.
